(19) United States
(12) Patent Application Publication
(10) Pub. No.: US 2014/0076831 A1
(43) Pub. Date: Mar. 20, 2014

(54) Adaptable Telecommunications Equipment Mounting Frame

(71) Applicant: Richard Mathewson, Mission Viejo, CA (US)

(72) Inventor: Richard Mathewson, Mission Viejo, CA (US)

(21) Appl. No.: 14/089,595

(22) Filed: Nov. 25, 2013

Related U.S. Application Data
(63) Continuation of application No. 13/400,870, filed on Feb. 21, 2012.

(51) Int. Cl. H04Q 1/02

(52) U.S. Cl. CPC H04Q 1/09
USPC 211/26

(57) ABSTRACT

A prism-like frame for mounting telecom equipment made of a prism-like skeleton, which in turn is made of at least three vertical members coupled with at least six horizontal members, and at least one open panel connected to at least one lateral side of the skeleton, wherein the panel includes at least two horizontal members arranged apart from each other and away from the bottom and the top of the skeleton.

### CROSS-REFERENCE TO RELATED APPLICATIONS

This application is a continuation and claims the benefit of U.S. Non-Provisional Application No. 13/400,870, filed Feb. 21, 2012, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1.Field of the Invention

The invention relates generally to mounting frames for telecom units and more particularly to a new, compact and versatile mounting frame for telecom units.

2. Description of the Related Art

The wireless cell site equipment is changing from a few large equipment cabinets to many small cabinets and miscellaneous equipment which includes RRU (Remote Radio Unit), OBIF (Optical Basestation Interface), or PBC-02 (Power and Battery Cabinet-02). Furthermore, there are space limitations in the field of so called leased area and they restrain future growth.

There are currently available on the market frames that may be used to mount telecom units or equipment such as RRU, OBIF or PBC-02. Examples of such frames are shown in FIGS. 1a-c. The frame in FIG. 1a consists of two Facilities Interface Frame (FIF) racks with UNISTRUT® brackets (i.e., long connecting brackets), which provide a horizontal plane to mount telecom equipment or units. This frame also allows equipment to be installed on the reverse side as in a back to back arrangement.

FIG. 1-b depicts an H-Frame consisting of two vertical pipes with UNISTRUT® brackets, which provide a horizontal plane to mount telecom equipment. This design also allows equipment to be installed on the reverse side, as in a back to back configuration. It is also possible to utilize only the UNISTRUT® brackets and mount the RRU, OBIF, or PBC-02 directly to the wall without any vertical supports.

FIG. 1-c shows another existing frame, a pipe mount design, consisting of an RRU, OBIF, or the like, mounted to a vertical pipe, via mounting brackets, creating a vertical plane to mount equipment. This design also allows equipment to be installed on the reverse side, as in a back to back scenario.

The problem with using any of the existing frame designs is that they are not conducive to equipment consolidation, and thus, space, which is often very expensive, is wasted. The current designs require either a high vertical space for mounting on a pole, or a large horizontal space such as when using the H-Frame design, the two FIF rack design, or the wall mounted design. In the wireless industry, when building cell sites, the carriers are required to secure leased space through a lease agreement. That leased space is what drives the need for equipment consolidation, because the space is often very small and/or very expensive. The more consolidation, the more room for growth, and this is what all the carries seek out. Thus, there is a need for a new, compact and versatile mounting frame, which allows for the telecom equipment to be consolidated into more compact and versatile, yet functional configurations that make highly efficient use of the space available to telecom companies.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, the new adaptable mounting frame is a four-sided frame which has one or more doors, and which is configured to permit compact and versatile mounting of telecom equipment. Thus, an advantage is that it condenses the footprint of the telecom equipment, which saves a considerable amount of economic resources. Another advantage is that this is a versatile design because, among other things, it can be mounted in the middle of the room, against a wall, indoor, outdoor, and so on, and because it can also be expanded in width, depth, and/or height. Thus, this is a versatile and compact mounting frame that solves the known problems with the prior art described above.

Again, the wireless cell site equipment is changing from a few large equipment cabinets to many small cabinets and miscellaneous equipment which includes RRU, OBIF, and PBC-02. The disclosed frame will be able to reduce the foot print of the new wireless equipment by arranging the equipment in a way which utilizes all horizontal and vertical space.

In addition, again, the space restraints in the field of so called leased area limit future growth. The disclosed frame can be built in various shapes and sizes as described below. Thus, by using the new adaptable frame, wasted or dead space is eliminated, any available space is utilized and equipment count is maximized. By fully utilizing the leased space the wireless carriers can save money by not having to expand leased area to accommodate new wireless equipment.

The above embodiment(s) and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1a illustrates the perspective view of an existing frame design for mounting telecom units, using two Facilities Interface Frame (FIF) racks and UNISTRUT® brackets.

FIG. 1b illustrates the perspective view of an existing H-frame for mounting telecom units, using vertical pipes and UNISTRUT® brackets.

FIG. 1c illustrates the perspective view of an existing system for mounting telecom units, using vertical pipes and mounting brackets.

FIG. 2 illustrates the elevation view of the new adaptable mounting frame for telecom units, according to one embodiment.

FIG. 3 illustrates the plan view of the new adaptable mounting frame from FIG. 2.

FIG. 4 illustrates the perspective view of a one-door version of the new adaptable mounting frame, with the door in close position, according to another embodiment.

FIG. 5 illustrates the perspective view of the one-door version of the new adaptable mounting frame from FIG. 4, with the door in open position.

FIG. 6 illustrates the perspective view of a two-door version of the new adaptable mounting frame, with the doors in open position, according to another embodiment.

FIG. 7 illustrates the perspective view of a three-door version of the new adaptable mounting frame, with the doors in open position, according to another embodiment.

FIG. 8 illustrates the perspective view of a four-door version of the new adaptable mounting frame, with the doors in open position, according to another embodiment.

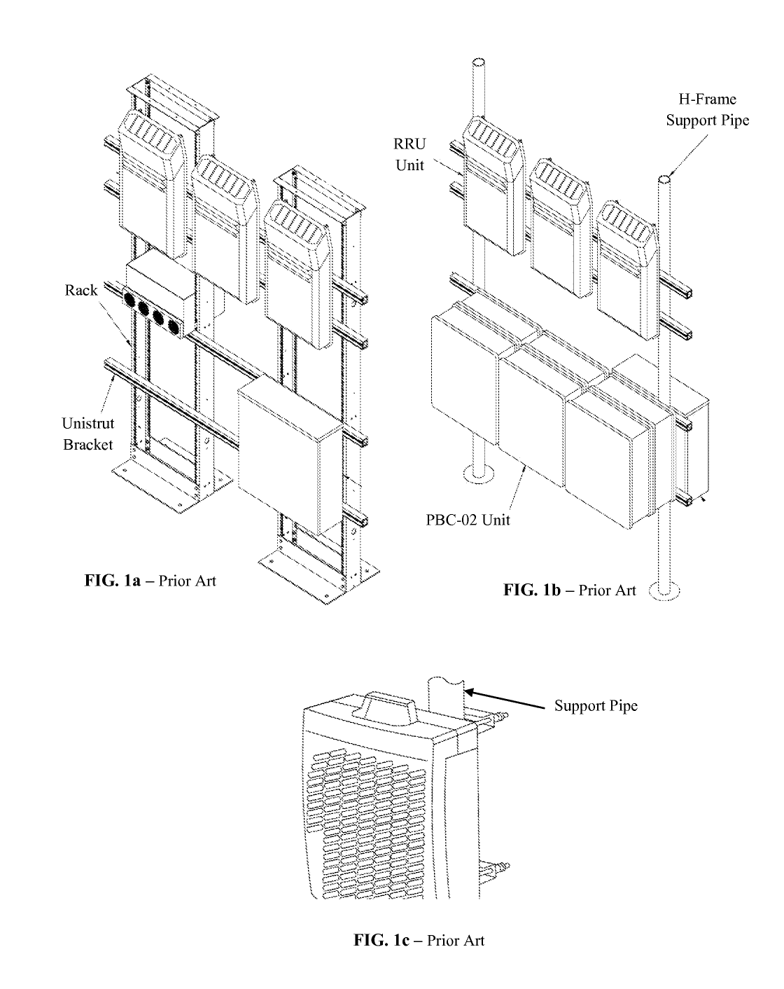

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

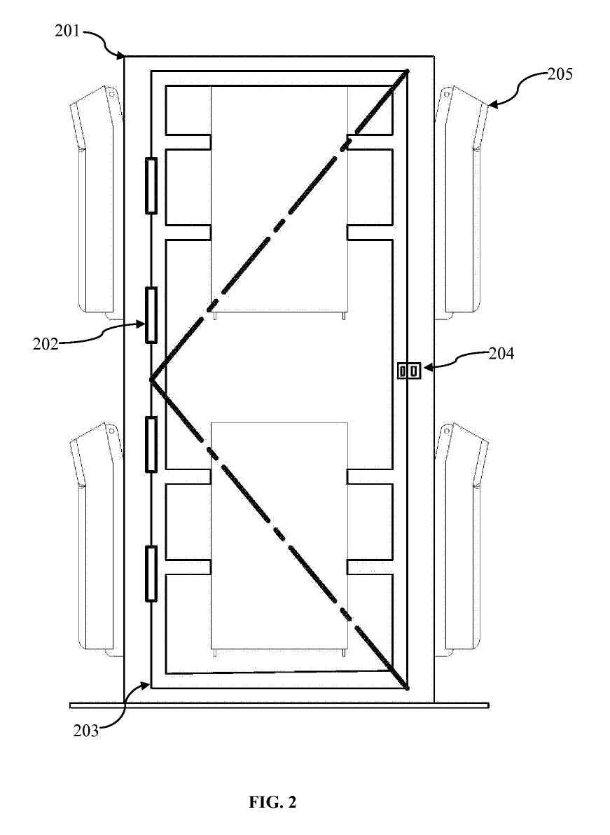

Referring now to FIGS. 2, 3 and 4, it is shown that the new adaptable mounting frame 400 for telecom units or equipment may be have a shape similar to that of a rectangular prism, which may be made by building a rectangular prism-like skeleton 201, 301, 401, having four vertical members coupled or associated with eight horizontal members (four at the bottom and four at the top), and by removably or irremovably associating with each of the lateral faces (“lateral sides,” “sides”) of the skeleton, a panel 408. The irremovable association, coupling or attachment may be accomplished by any standard technique known in the art such as by welding. The removable attachment may also be achieved by any standard and known techniques in the art, such as by using screws to secure the panel 408 to skeleton 401.

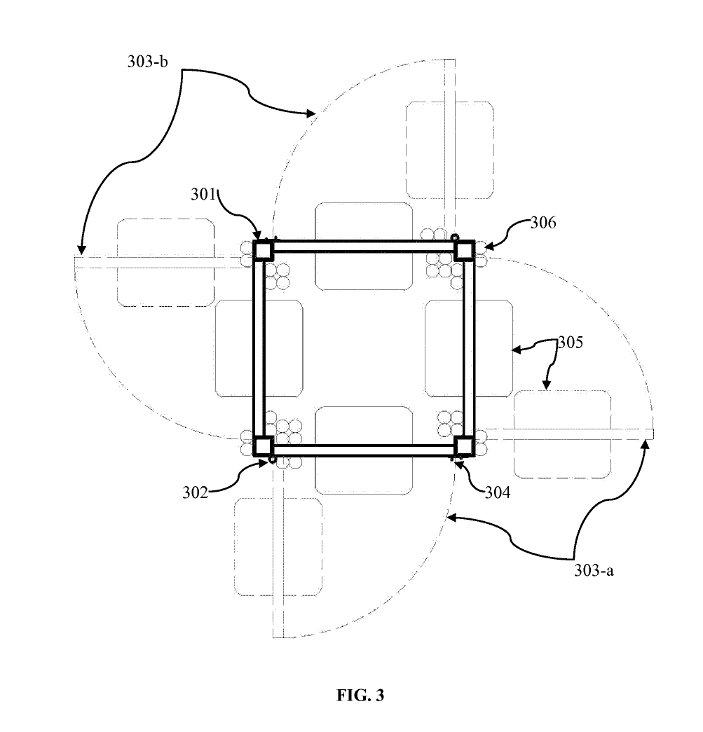

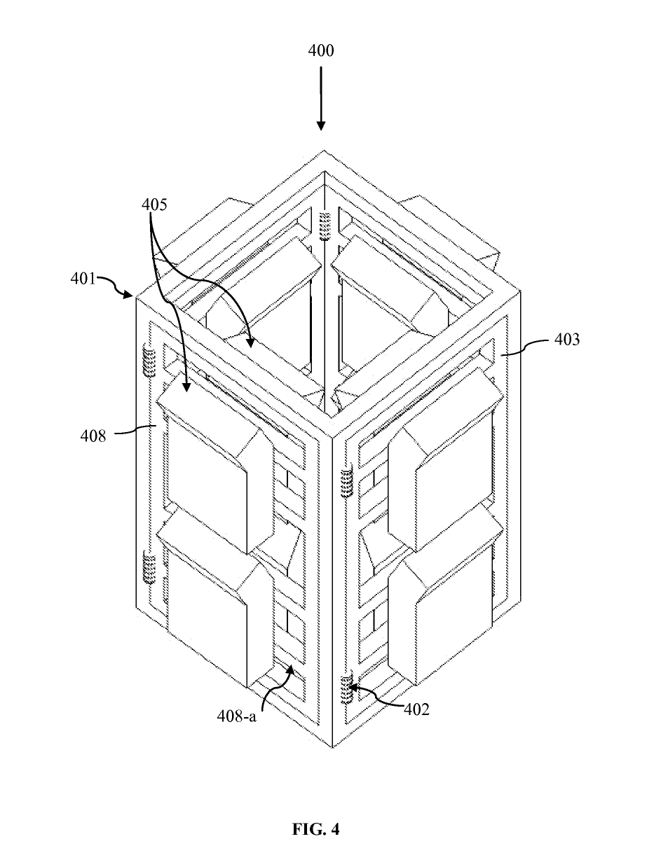

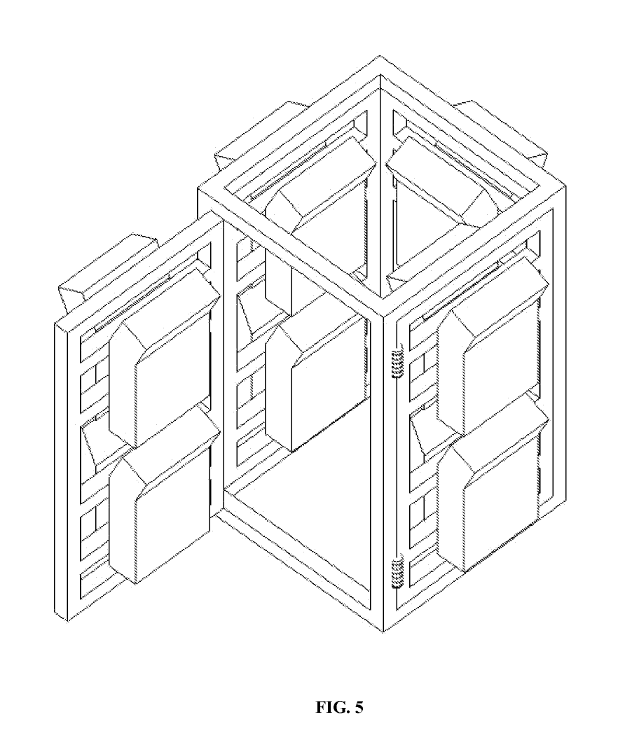

As shown in FIG. 4, the panel 408 has an open (i.e., skeleton-like, frame-like, as opposed to a panel of a cabinet) appearance itself (“open panel”), and it may be made of four exterior members, two vertical and two horizontal, and four interior and horizontal members 408-a, and nothing in between them. As shown, two of the interior members are grouped at the bottom and two of the interior members are grouped at the top of the panel 408. Each group of two is used for mounting telecom units or equipment 405 (205 and 305 in FIG. 2 and FIG. 3, respectively) on each side of the panel 408. Thus, each panel may accommodate four telecom units (two on each side), which means that the adaptable mounting frame 400 may accommodate a total of sixteen units. The telecom equipment or units 405 may be RRU (Remote Radio Unit), OBIF (Optical Basestation Interface), PBC-02 (Power and Battery Cabinet-02), and/or other similar equipment or units.

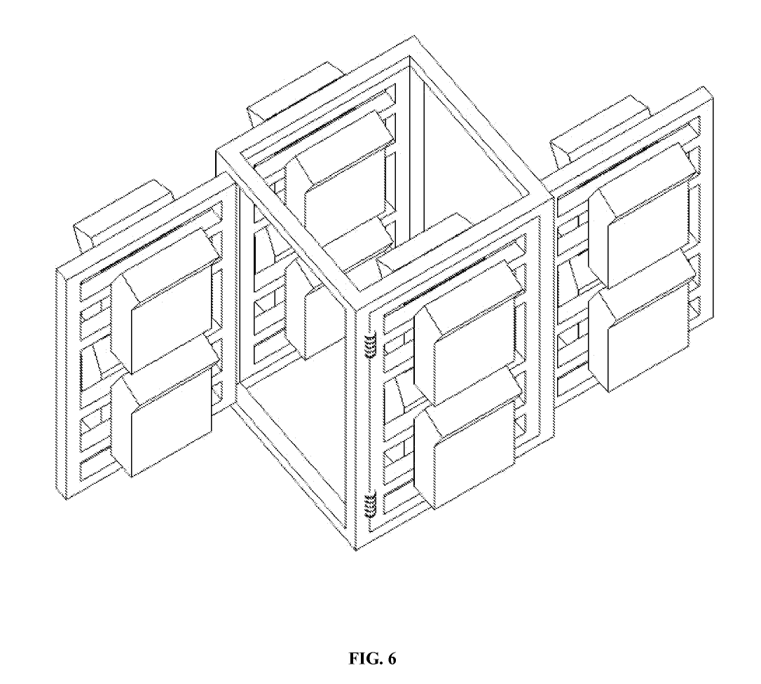

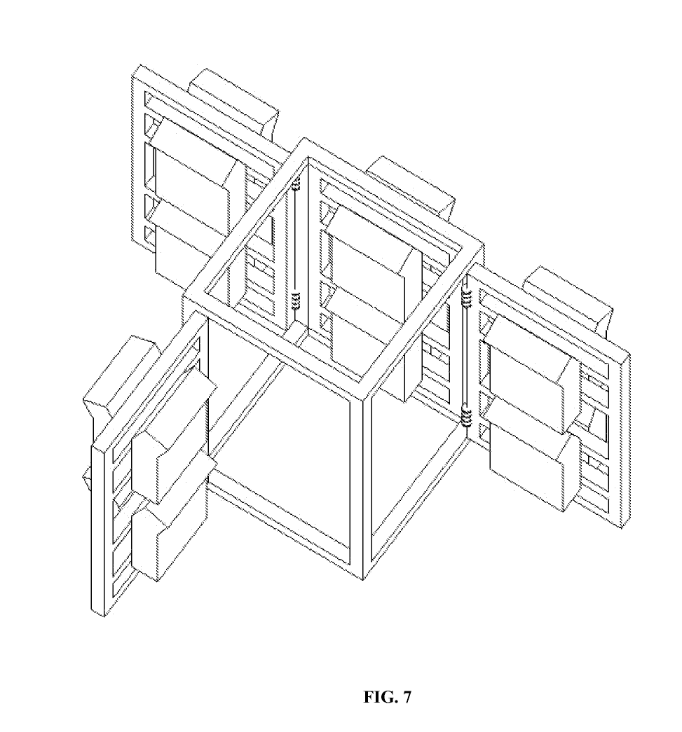

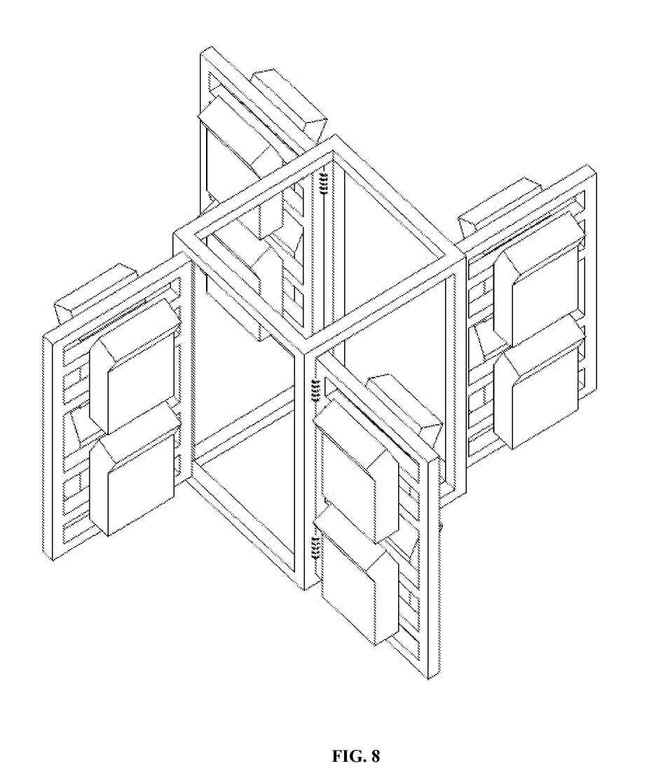

As shown in FIGS. 2,3 and 4, the panel 408 may be attached to the skeleton 201, 301,401 by using two or more known hinge mechanisms 202, 302, 402 and one or more locking mechanisms 204, 304 (not shown in FIG. 4). It should be apparent that in this case, the panel becomes a door 203, 403, which may be opened (see 303-a and 303-b in FIG. 3) to access the inside of the adaptable mounting frame 400 when needed, for purposes such as mounting or demounting the telecom units 205, 305, 405 inside the frame 400 and/or on the other side of the door/panel. It should also be apparent that at least one door (or, alternatively, one removable panel) is needed to conveniently access the inside of the frame 400. However, one of ordinary skills in the art would recognize that two (see FIG. 6), three (see FIG. 7) or four doors (see FIGS. 3 and 8) may be used, without departing from the scope and essence of the invention. One factor that has to be considered when deciding with how many doors to equip the frame 400 is the door swing clearance needed, as shown in FIG. 3 (303-a, 303-b).

It should be understood that, alternatively, the panel 408 as well as the door 403 may be replaced, for the purpose of saving material and/or manufacturing costs for example, by two (one at the bottom and one at the top) smaller panels or doors, each comprising substantially only two (the bottom two or the top two, respectively) interior members 408-a (with some vertical elements used at each end to connect the two respective interior members). Then, each of the smaller panel (one at the top and one at the bottom on each side of the frame 400) may be secured to the skeleton 401 by, for example, welding, using of screws, or by using a hinge and a locking mechanism as explained above.

It should also be apparent that each side of the frame 400 may have a combination of door and panel such as a panel on the bottom half of the side and a door on the top half of the same side.

In addition, the panel 408 may be also reduced to simply its interior/horizontal members, which may then be coupled directly with the skeleton 401.

It should be noted that, as shown in FIG. 3, utility cables 306, such as but not limited to coaxial cable, fiber optics and the like, may be conveniently secured or fastened to the frame. Seismic hooks may also be added to the frame for securing cables in indoor scenarios.

It should also be understood that other modifications made be made without departing from the scope and essence of the invention. For example, instead of having a frame 400 that may accommodate, as shown, two levels of equipment units (eight units on the bottom level and eight units at the top level) the frame may be reduced in half (one level (i.e., eight units) only) or it may built such that it has three levels (twenty four units total) or even more levels.

In addition, although the emphasis herein was on a rectangular prism-like shape, the disclosed adaptable mounting frame may work equally well, as described, in a triangular prism-like configuration, when the frame would have three lateral faces (“sides”) instead of four as described above. Preferably, a triangular prism-like frame would have all three sides equal in width for an easier and more space efficient arrangement of multiple frames, on, for example, the floor of a building.

Furthermore, this new and adaptable mounting frame may have other shapes, such as hexagonal, octagonal, and so on, prism-like shapes, in order to, for example, accommodate more equipment or to fit better in the space allotted. Also, the frame can have various sizes in regards to its width, depth, and height depending on, for example, the size of the equipment to be mounted, the space requirement for leased space, building codes, or the field conditions.

The frame's 400 versatile design allows it to be used in interior or exterior spaces and, if needed, in a stackable arrangement to fill the vertical space available inside of a building or outside (e.g., on top of a building). The frame may be anchored to the ground, the roof of a building and so on, with optional mounting depending on the local building codes. Furthermore, the frame can have various sizes in regards to width, depth, and height depending on space requirement for lease space or field condition.

The frame may be made of materials such as steel, aluminum, fiber reinforced plastic (FRP), or other composite materials. The frame can be painted or finished for durability and/or camouflage to the surrounding area.

The open concept of the disclosed frame (no panels on top and bottom of the frame and nothing in between the interior members 408-a) makes the frame advantageous in terms of decreased weight, lower manufacturing costs and better cooling of equipment. Furthermore, it permits the mounting of multiple equipment units and to access them with ease rather than trying to pull everything out of the frame to access them. It also allow for less wind loading (when running structural calculations) since this is not a solid design like standard cabinets are.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although specific embodiments have been illustrated and described herein for the purpose of disclosing the preferred embodiments, someone of ordinary skills in the art will easily detect alternate embodiments and /or equivalent variations, which may be capable of achieving the same results, and which may be substituted for the specific embodiments illustrated and described herein without departing from the scope of the invention. Therefore, the scope of this application is intended to cover alternate embodiments and /or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A frame for mounting telecom equipment configured to stand on a horizontal surface comprising a skeleton, made of at least three vertical members associated with at least six horizontal members, said at least six horizontal members being associated to form two polygonal shapes, and such that the skeleton has a bottom side, a top side, and at least three, all adjoining, lateral sides, and at least one open panel associated with at least one lateral side of the skeleton, wherein the at least one open panel comprises at least two horizontal members arranged apart from each other and away from the bottom and the top edge of the at least one open panel.

2. The frame of claim 1, wherein the open panel has a rectangular shape and consists of a bottom horizontal member, a top horizontal member and two vertical members, all four members being associated such that to create the rectangular shape, and four horizontal members coplanar with the rectangular shape and associated at their ends, at a right angle, with the vertical members, two of the horizontal members being grouped at the bottom and two of the horizontal members being grouped at the top of the open panel, such that, on each group of horizontal members, two telecom equipment units can be mounted, one on each side of the open panel.

3. The frame of claim 1, wherein each lateral side of the skeleton has an open panel associated with it, and wherein at least one of the open panels is associated with the skeleton through a combination of hinge and locking mechanism, such that the at least one of the panels functions as a door.

4. The frame of claim 1, wherein the skeleton has four lateral sides, wherein each lateral side of the skeleton has an open panel associated with it, and wherein at least one of the open panels is associated with the skeleton through a hinge, and wherein the exterior surface of all open panels is coplanar with the exterior surface of the associated lateral side of the skeleton when the open panels are in closed position.

5. The frame of claim 4, wherein each open panel comprises two vertical members associated with at least two horizontal members.

6. A mounting frame for mounting telecom equipment and configured to stand on its own on a horizontal surface, the mounting frame comprising: a main frame comprising four vertical members associated at each of their upper and bottom end with a group of four rectangularly arranged frame horizontal members, such that the main frame has four vertical sides, and, four side frames, one on each of the four vertical sides, wherein at least one of the four side frames is pivotally attached to the main frame and wherein each of the four side frames comprises two mounting horizontal members being grouped in the bottom half of the side frame and two mounting horizontal members being grouped in the top half of the side frame, such that, on each group of mounting horizontal members, telecom equipment can be mounted on each side of the four side frames.

7. The mounting frame of claim 6, wherein all four side frames are pivotally attached to the main frame.
